(19) United States
(12) Patent Application Publication
(10) Pub. No.: US 2006/0217929 A1
(43) Pub. Date: Sep. 28, 2006

(54) Lifetime support process for rapidly changing, technology-intensive systems

(75) Inventors: Jack Gellen, Falls Church, VA (US); Michael E. Feeley, Cliffton, VA (US); Thomas E. Herald JR., Warrenton, VA (US); David J. VanBuskirk, Gainesville, VA (US); Eric V. Gruenloh, Fairfax, VA (US)

Correspondence Address: GRAYBEAL JACKSON HALEY LLP;Suite 350, 155-108th Avenue N.E., Bellevue, WA, 98004-5973, US

(73) Assignee: Lockheed Martin Corporation

(21) Appl. No.: 11/199,573

(22) Filed: Aug. 8, 2005

Related U.S. Application Data
(60) Provisional application No. 60/599,398, filed on Aug. 6, 2004.

(51) Int. Cl. G21C 17/00

(52) U.S. Cl. 702/184

(57) ABSTRACT

A system is operable without repair for a predetermined maintenance-free operating period (MFOP). The system includes a first portion that is operable to perform a function, a second portion, and a control portion coupled to the first and second portions. The control portion is operable to cause the second portion to perform the function for a remainder of the MFOP if the first portion fails during the MFOP. For example, a system on board a submarine that comes in to port every ninety days can have a ninety-day MFOP. Therefore, crewmembers do not need to repair the system while the submarine is at sea on a mission. This servicing strategy may reduce costs by allowing one to eliminate training crew to repair the sonar system, preparing and printing repair documentation for the crew, and carrying this documentation, spare parts, and repair equipment on board the submarine.

### CLAIM OF PRIORITY

This application claims priority to U.S. Provisional Application Ser. No. 60/599,398, filed on Aug. 6, 2004, which is incorporated by reference.

### CROSS-REFERENCE To RELATED APPLICATIONS

This application is related to U.S. patent application Ser. No. 10/440,438, filed May 15, 2003, entitled “METHOD AND APPARATUS FOR ESTIMATING THE REFRESH STRATEGY OR OTHER REFRESH-INFLUENCE PARAMETERS OF A SYSTEM OVER ITS LIFE CYCLE”, and Ser. No. 10/440,032, filed May 15, 2003, entitled “METHOD AND APPARATUS FOR ESTIMATING THE REFRESH STRATEGY OR OTHER REFRESH-INFLUENCED PARAMETERS OF A SYSTEM OVER ITS LIFE CYCLE”. Both of these applications are incorporated by reference.

### INCORPORATION OF ADDITIONAL MATERIAL

The references cited in the Information Disclosure Statement filed with this application are incorporated by reference.

### BACKGROUND

One typically desires to minimize the cost of developing, producing, and servicing a system, such as a sonar system, disposed within a plant, such as a submarine, over the anticipated life cycle of the system. The periods during which the system is accessible for various levels and types of servicing (e.g., the periods during which a submarine is at sea, in port, at dry dock for overhaul) and the lifetimes and lifecycles of the parts that compose the system often affect the servicing cost significantly, particularly where some or all of the parts are commercial off-the-shelf (COTS) parts.

Servicing events for a system and/or a part of the system include maintenance, technology refresh, and technology insertion.

Generally, there are many types of maintenance, three of which are: corrective, preventative, and prognostic. Corrective maintenance is the repair or replacement of a system or of a part within the system when the system or part fails, i.e., “fix it when it breaks.” Preventative maintenance is scheduled in advance to prevent system/part failure, and is typically triggered by a predetermined occurrence. An example of preventative maintenance is changing the motor oil in ones automobile every 3000 miles. Prognostic maintenance relies on a sensor within the system to indicate the impending failure of the system or of a part of the system. An example of prognostic maintenance is replacing a refrigerator water filter in response to a sensor indicating that the water filter has nearly exhausted its capacity to filter water. These and other types of maintenance are discussed in Blanchard, B. S., Verma, D., Peterson, E. L., Maintainability—A Key to Effective Serviceability and Maintenance Management, Wiley-Interscience Publication, John Wiley & Sons, Inc., New York, N.Y., 1995 (e.g., pages 15-16), which is incorporated by reference.

Furthermore, a system, and/or each part that composes the system, often has multiple levels of maintenance, these levels corresponding to the respective levels of difficulty associated with performing the above types of maintenance. For example, suppose that a sonar system includes a Hewlett-Packard® computer server, which has three levels of maintenance. The first level, i.e., low level, includes relatively basic repairs, such as the replacement of a plug-in circuit board, that one can perform while the server is installed within the sonar system—note that the replacement of the board may be corrective, preventative, or prognostic maintenance. The second level, i.e., intermediate level, includes repairs of intermediate difficulty, such as the replacement of the server's cooling mechanism, that one can perform only after removing the server from the system. That is, one may be unable to access the server's cooling mechanism without removing the server from the sonar system, and the need to remove the server to effect the repair increases the overall difficulty of the repair. The third level, i.e., higher level, includes relatively difficult repairs, such as the resetting of a encryption security code, that only can be performed at “the factory,” i.e., at one of Hewlett-Packard's facilities.

Technology refresh is the replacement of one or more earlier-generation parts of a system with parts of a later generation because the earlier-generation parts are, or soon will be, obsolete. After the refresh, the functional capacity of the system is typically the same as or greater than the functional capacity of the system before the refresh. For example, suppose a system includes ten Pentium® II processors that allow the system to process up to 10 megabytes of data per second (10 Mb/s). One may refresh the system by replacing the ten Pentium® II processors with five Pentium® II or other later-generation processors, which allow the system to process data at a rate of 10 Mb/s or more. One refreshes a system because the generations of the parts being replaced are at or are nearing the ends of their life cycles, and thus are or soon will be unavailable or cost prohibitive to support. For example, after Intel® introduced the Pentium® μl and Pentium® IV generations of processors, it slowed and then stopped production of the Pentium® II generation. Therefore, at some point, a Pentium® II processor became unavailable, or so difficult/expensive to obtain or support that it was virtually unavailable. Consequently, at some point, one would need to replace a Pentium® II processor with a later-generation processor such as a Pentium® II or Pentium® IV processor. This refresh may be as simple as inserting the later-generation processor into the socket previously occupied by the Pentium® II processor, or may require modifications to the system such as the replacement of the processor board with a newer processor board design to accept a later-generation processor.

Technology insertion is the replacement of one or more earlier-generation parts of a system with parts of a later generation to increase the functional capacity of the system and/or to migrate to a different technology. For example, suppose a system includes ten Pentium® II processors that allow the system to process up to 10 Mb/s. To increase the system's data-processing speed and/or to avail the system of advances in data-processing technology other than processing speed, one may insert technology into the system by replacing the ten Pentium® II processors with ten Pentium® II or other later-generation processors. A major distinction between technology refresh and technology insertion is that one typically must refresh a system or part because the system or part is or soon will be obsolete, whereas one typically chooses to insert technology into a system or part not because he has to, but because he wants to upgrade the system capabilities or part to newer technology. In short, technology refresh typically must occur, but technology insertion is optional.

Unfortunately, the cost of servicing a conventional system or part of the system is often relatively high. For example, because the system and/or part may theoretically fail at any time, one typically must have repair equipment and personnel available at all times during which the system is functioning. Moreover, performing maintenance, technology refresh, and technology insertion independently of one another may lead to redundant part replacement in the system, and redundant testing, engineering integration, and re-certification of the system.

Furthermore, as explained below in conjunction with FIG. 1, the plant in which a system is installed may impose restrictions that further increase the cost of servicing of the system or a part of the system.

FIG. 1 is a conventional servicing strategy 10 for a system (not shown in FIG. 1), such as a sonar system, disposed within a plant (not shown in FIG. 1), such as a submarine, over a portion of the system's anticipated life cycle. Although discussed in terms of a system, the servicing strategy 10 may also apply to one or more parts of the system in addition to the entire system.

The servicing strategy 10 is designed around the anticipated system-accessibility periods ALn, where n is the level of system accessibility during a particular accessibility period—the servicing strategy 10 is shown having three levels of system accessibility although it may have more or fewer than three levels). The system-accessibility periods ALn may be a function of, e.g., the system itself, the availability of maintenance personnel and equipment, or the accessibility of the plant in which the system is installed. For example, for a particular system on board a submarine, the periods AL1 (periods where a system on the submarine is generally hardest to access) coincide with the times that the submarine is at sea, i.e., on a mission. Because the submarine is on a mission, the system is not readily accessible to shore-based personnel, equipment, and parts inventory; thus the system has a relatively low-level of accessibility because it is relatively difficult for shore-based maintenance personnel to access and work on. The periods AL2 (periods where a system is generally easier to access) coincide with the submarine's times in port for crew changes and supply pick up. Because the submarine is in port, the system is more readily accessible to shore-based personnel, equipment, and parts inventory; thus the system has an intermediate-level of accessibility because it is easier for the shore-based personnel to access than when the submarine is at sea. The periods AL3 (periods where a system is generally easiest to access) coincide with the submarine's times in dry dock for overhaul, where the dry dock is specialized for outfitting and refurbishing submarines. Because the submarine is being overhauled, the system is readily accessible, e.g., to the most highly trained shore-based personnel, the best equipment, and the largest parts inventory. Furthermore, a system may require partial dismantling of the submarine before one can access all or part of the system; typically, such dismantling can be performed only during overhaul. Therefore, when the submarine is being overhauled, the system has a relatively high-level of accessibility, i.e., is relatively easy to access. Because the periods ALn are contiguous, the system is always accessible to some degree in this example.

During the periods ALn, one can perform respective levels MLn of maintenance, and can also perform technology refresh R and technology insertion T. More specifically, the maintenance levels MLn, which respectively coincide with the accessibility periods ALn, are the levels of repair that one can perform during respective periods ALn if the system fails. For example, during the periods AL1, because the submarine is at sea, the knowledge of the crew in repairing the system, and the variety of repair equipment and the parts inventory on board the submarine may be limited; therefore, the crew can typically perform only basic-level ML1 maintenance (e.g., replacing a failed plug-in board, reloading software) on the system. During the periods AL2, because the submarine is in port, experienced system life cycle integrator shore-based personnel, who have access to a greater variety of information, equipment, and materials, can typically perform more detailed maintenance on the system. And during the periods AL3, because the submarine is being overhauled, the shore-based personnel have access to the greatest variety repair options, e.g., repair equipment, the largest parts inventory, and submarine-dismantling equipment, and thus can typically perform (or have performed) relatively high-level maintenance on the system.

Of course if the system suffers an intermediate- or high-level failure (i.e., a failure requiring an ML2 or ML3 level of repair) while the submarine is on a mission, then the submarine may need to make an unscheduled return to port or dry dock for repair, and thus effect an unscheduled change to the level of the system's accessibility.

Furthermore, one can perform lower-level maintenance on the system during a higher-level accessibility period ALn. For example, if replacing a plug-in circuit board is lower-level maintenance that can be performed during periods AL1 when the submarine is on a mission, then one can also replace the circuit board during periods AL2 and AL3. In contrast, one cannot perform higher-level maintenance to the system during a lower-level accessibility period ALn. For example, if replacing a plug-in circuit board is intermediate-level maintenance that must be performed during periods AL2 or AL3 when the submarine is in port or depot, then one cannot replace the circuit board during periods AL1 when the submarine is at sea.

Moreover, because a rapidly changing technically intensive system can typically fail at any time, the servicing strategy 10 requires one to at all times be prepared to perform at least a low-level of corrective maintenance on the system.

Still referring to FIG. 1, in this example maintenance M is corrective maintenance, and is thus not scheduled in advance. Furthermore in this example, refresh R of the system or parts within the system is scheduled in advance, and technology insertion T to the system or to parts within the system may or may not be scheduled in advance. As discussed above, because one cannot predict the failure of the system or a part of the system in an absolute sense, he cannot schedule corrective maintenance in advance; that is, he cannot schedule a repair until the system actually fails. Consequently, although one typically must be prepared to perform maintenance to the system at a respective level MLn during all accessibility periods ALn, he actually performs the maintenance only when the system fails. In contrast, because one can often predict the life cycles of systems and parts of the systems, then one can, and often does, schedule refresh R of the system or parts of the system far in advance, for example, before the acquisition of the system. For this same reason, one may also schedule technology insertion T in advance. But sometimes, one schedules technology insertion Ton an ad hoc basis in response to, e.g., new technology. For example, suppose a computer system is running the Windows® 2000 operating system when Windows® XP is introduced. To provide the computer system with the additional features provided by the newly available operating system, one may decide to insert technology by installing Windows® XP on the computer system.

Still referring to FIG. 1, one problem with the servicing strategy 10 is that one typically must be prepared to perform maintenance on a system at all times, i.e., during all accessibility periods ALn. The cost associated with such a continuous maintenance strategy is often substantial. For example, for a system on a submarine, the crew must be able to perform at least low-level maintenance ML1 on the system while the submarine is at sea. Consequently, the crew must be trained to make at least low-level repairs to the system, and the submarine must carry spare parts, repair manuals, and repair equipment. The costs for training crew, writing and printing repair manuals, and loading the manuals, spare parts, and repair equipment are substantial. Furthermore, the manuals, spare parts, and repair equipment occupy space, and the need for this space may increase the size of, and, therefore, the cost of acquiring, the submarine, and/or may reduce the space available for other items such as food. Moreover, before they are loaded onto the submarine, the spare parts are often inventoried in a warehouse at additional cost. In addition, if the system experiences an intermediate- or high-level failure while the submarine is at sea, and the failure renders the system incapable of performing a function that is critical to the mission, then one must suspend the mission and take the submarine to port or dry dock so that shore-based personnel equipped to perform ML2- and ML3-level maintenance can make the necessary repairs. Depending on, e.g., the type of mission and the distance to port or dry dock, the cost and consequences of suspending the mission can be staggering.

Referring to FIGS. 1 and 2A-2E, another problem with the servicing strategy 10 is that the periods ALn during which maintenance M, refresh R, and technology insertion T occur are often unsynchronized. As illustrated by the following example in which the service-accessibility periods AL1 are each ninety days long, the costs associated with the unsynchronized occurrence of maintenance, refresh, and technology insertion are often substantial.

Referring to FIG. 2A, a system 20 on a submarine (not shown) initially includes ten first-generation processors 22₁-22₁₀, e.g., ten Pentium® I processors (only the processors 22₁, 22₁, and 22₁₀ are shown).

Referring to FIGS. 1 and 2B, at a time t₁ the system 20 fails, but is repaired. Specifically, the first-generation processor 22₂ fails, and one replaces it with an identical, spare first-generation replacement processor 24₂ and then tests the system 20 to confirm that the system is operational—in this example the replacement of the processor 22₂ is a low-level of maintenance ML1, and thus can be performed by crew while the submarine is at sea.

Referring to FIGS. 1 and 2C, at a time t₂ one performs a scheduled refresh R to the processors of the system 20 by replacing the nine original first-generation processors 22₁ and 22₃-22₁₀ and the spare first-generation processor 24₂ with five second-generation processors 26₁-26₅, e.g., five Pentium® II processors (only the processors 26₁, 26₂, and 26₅ are shown). After one installs the five second-generation processors 26₁-26₅, he tests the refreshed system 20, which has substantially the same data-processing capacity as before the refresh, to confirm that the system is operational.

Referring to FIGS. 1, 2B, and 2C, because one replaces the spare first-generation processor 24₂ with the second-generation processor 26₂ fewer than ninety days after installing the spare processor 24₂, he has incurred the full cost of the spare processor 24₂ even though the system 20 has benefited from only a small portion of this spare processor's anticipated lifetime. Furthermore, one incurs the cost of working on and testing the system 20 twice—once for maintenance and once for refresh—within fewer than ninety days.

Referring to FIGS. 1 and 2D, at time t₃ one inserts technology into the processors of the system 20 by replacing the five second-generation processors 26₁-26₅ with five third-generation processors 28₁-28₅, e.g., five Pentium® III processors. After one installs the five third-generation processors 28₁-28₅, he tests the system 20 to confirm that the system is operational.

Referring to FIGS. 1, 2C, and 2D, because one replaces the five second-generation processors 26₁-26₅ with the five third-generation processors 28₁-28₅ (i.e., inserts technology) merely six months (one hundred eighty days) after installing (i.e., refreshing) the processors 26₁-26₅, he has incurred the full cost of the processors 26₁-26₅ even though the system 20 has benefited from only a small portion of these processors' anticipated lifetimes. Furthermore, one incurs the cost of working on and testing the system 20 twice—once for refresh and once for technology insertion—within six months.

Therefore, a need has arisen for an improved servicing strategy and a system that supports such an improved servicing strategy.

### SUMMARY

An embodiment of the invention is a system that is operable without maintenance for a predetermined period of time called a maintenance-free operating period (MFOP). The system includes a first portion that is operable to perform a function, a second portion, and a control portion coupled to the first and second portions. The control portion is operable to cause the second portion to perform the function for a remainder of the MFOP if the first portion fails during the MFOP.

The cost of maintaining such a system or a part thereof is often reduced because one need not perform any maintenance during the MFOPs. For example, one need not have trained repair personnel, repair equipment, repair manuals, spare parts, etc. available during the MFOPs.

Furthermore, where such a system is installed in plant that has service-accessibility periods of different levels, one can synchronize the MFOP with the accessibility periods to save servicing costs. That is, one can eliminate the need for maintenance during some of the accessibility periods, and consolidate maintenance at other, more convenient accessibility periods. For example, one can design a system (or one or more parts of a system) on board a submarine that comes in to port every ninety days to have an MFOP of at least ninety days. That is, one can eliminate the need for maintenance of the system during the periods of low-level accessibility when the submarine is at sea. Consequently, this servicing strategy reduces servicing costs by allowing one to eliminate training crew to repair the system, preparing and printing repair documentation for the crew, and carrying this documentation, spare parts, and repair equipment on board the submarine.

Moreover, one can further reduce servicing costs by synchronizing the MFOPs with the technology refresh and technology insertion to such a system or the parts of the system. Such synchronization can reduce the number of times that personnel replace a system part and perform follow-up testing of the system.

In addition, one can reduce costs even further by designing such a system or the parts of the system to eliminate the need for higher levels of maintenance. For example, if one designs a computer server of a sonar system so that all maintenance to the server can be performed while the server is installed in the sonar system, then this eliminates the need to remove the server from the sonar system, and also eliminates the need to send the server to the factory for high-level repairs. Where the sonar system is on board a submarine, one can perform all levels of maintenance to the server regardless of the location (e.g., at sea, in port, in dry dock) of the submarine. And where the computer server is designed to have MFOPs, then one can perform maintenance on the server at convenient times, such as when the submarine is in port.

### BRIEF DESCRIPTION OF THE DRAWINGS

FIG. 1 is a conventional servicing strategy for a system over a portion of the system's anticipated life cycle.

FIGS. 2A-2D illustrate a possible progression of servicing events performed on a system according to the servicing strategy of FIG. 1.

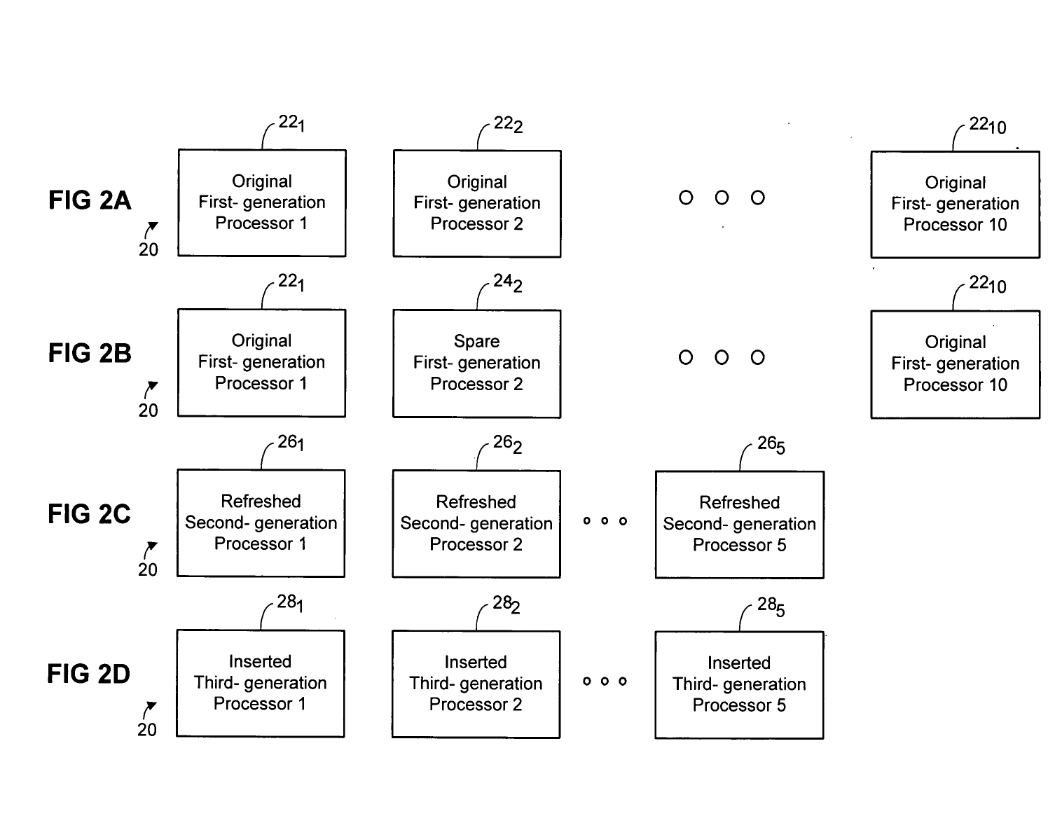

FIG. 3 is a servicing strategy for a system over a portion of the system's anticipated life cycle according to an embodiment of the invention.

FIG. 4 is a block diagram of a system that is compatible with the servicing strategy of FIG. 3 according to an embodiment of the invention.

FIG. 5 is a servicing strategy for systems in a plant over a portion of the systems' anticipated life cycles according to another embodiment of the invention.

### DETAILED DESCRIPTION

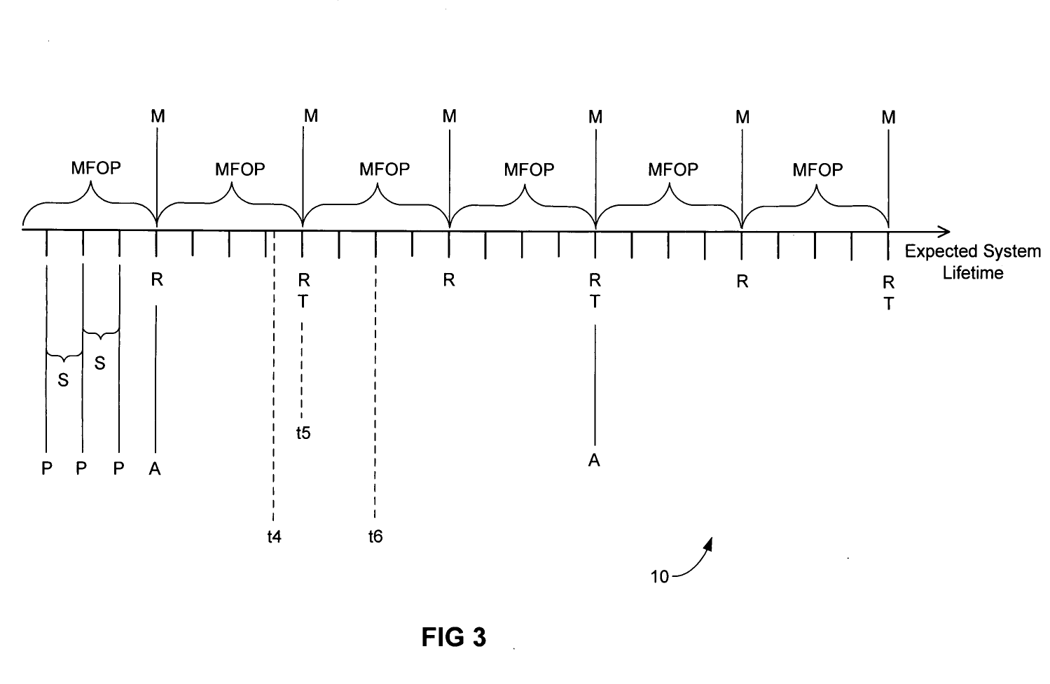

FIG. 3 is a servicing strategy 30 for a system (not shown in FIG. 3) that is part of a plant (not shown in FIG. 3) over a portion of the system's anticipated life cycle according to an embodiment of the invention. Although the system is described as having accessibility periods that are dependent on the location and other characteristics of a moveable plant (e.g., a submarine), one can apply the servicing strategy 30 to a system whose accessibility is independent of the plant in which the system is installed, such as a computer server in an office building. Furthermore, although described for a system, one can apply the servicing strategy 30 to one or more parts of the system.

Generally, the servicing strategy 30:
1) eliminates the need for system maintenance during predetermined maintenance-free operating periods (MFOPs);
2) synchronizes the periods during which system maintenance may be needed with the technology refresh of and the technology insertion to the system; and
3) eliminates higher levels of accessibility and maintenance.
   But other servicing strategies may implement any one or subcombination of these features according to other embodiments of the invention.

Consequently, the servicing strategy 30 may reduce servicing costs, as compared to a conventional servicing strategy, by allowing one to reduce or eliminate the costs associated with being prepared to repair the system at any time. For example, for a system on board a submarine and having MFOPs that coincide with the periods s during which a submarine is at sea, the servicing strategy 30 may allow one to reduce or eliminate the following costs associated with repairing the system while the submarine is at sea: training crew to repair the system, preparing and printing repair documentation for the crew, carrying this documentation, spare parts, and repair equipment on board the submarine, and suspending the mission to return to port or dry dock for repairs that the crew cannot perform. Furthermore, the servicing strategy 30 may allow one to further reduce costs by reducing the number of spare parts inventoried on shore, or by altogether eliminating an inventory of spare parts.

Moreover, by synchronizing repairing, refreshing, and inserting technology into the system, the strategy 30 may allow one to further reduce costs by reducing the number of times that a part of the system is replaced and the system tested, re-certified, and engineered.

And by eliminating one or more higher levels of accessibility or maintenance, the strategy 30 may yield additional cost reduction. For example, eliminating the need for a high-level of accessibility for systems on board a submarine allows one to perform servicing of all these systems while the submarine is in port, and, therefore, eliminates the need for the submarine to periodically be taken to dry dock for major maintenance and/or refurbishing of the systems. Because the time in dry dock could last six months or longer, the servicing strategy 30 increases the percentage of the systems' and submarine's life cycles during which the systems and submarine are available for missions.

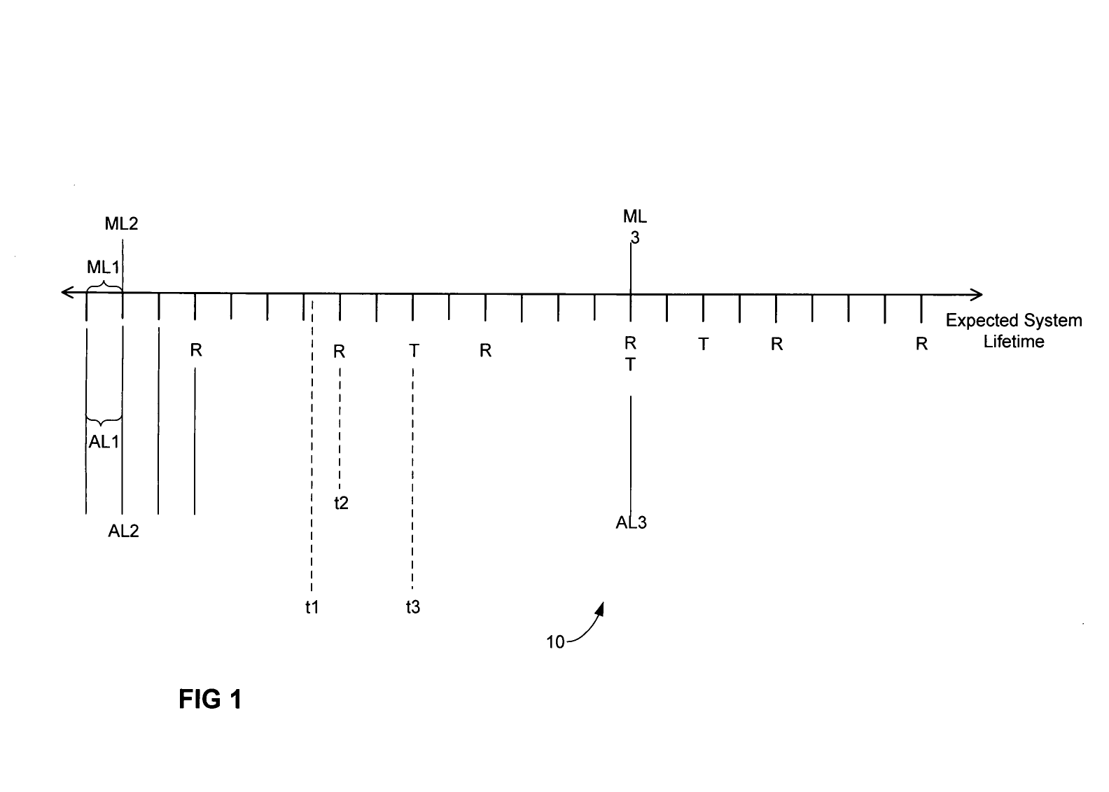

More specifically, the servicing strategy 30 includes system-accessibility periods A, which are separated by the system MFOPs and during which personnel perform all refreshes R, technology insertions T, and needed maintenance M to the system. For example, assume that the system is on board a submarine that performs missions having ninety-day periods s, and that thus returns to port every ninety days during periods p to pick up fresh crew, food, and other supplies—although in FIG. 1 the periods s and p were labeled as accessibility periods AL1 and AL2, respectively, in this example, although the system is technically accessible during these periods, these periods are not labeled as accessibility periods because ideally, no maintenance, refresh, or technology insertion occurs during these periods. Therefore, the MFOPs each span four missions; that is, the system on board the submarine is designed to operate for at least three hundred sixty days (approximately one year) without the need for maintenance M. Furthermore, refresh R of the system is also scheduled after every fourth mission (approximately every year), and technology insertion T is scheduled after every eighth mission (approximately every two years).

As discussed above, the servicing strategy 30 may allow a savings in maintenance costs because nothing required for repairing the system need be available during the MFOPs. For example, if the system is installed on a submarine that comes into port during the accessibility periods A, then no repair-trained crew, repair documentation, spare parts, or repair equipment for the system are needed on the submarine while the submarine is on a mission. Instead, trained, shore-based service personnel can make any needed repairs while the submarine is in port. And if all of the systems on the submarine are designed to have MFOPs that span at least the duration of a mission, then no repair-trained crew, repair documentation, spare parts, or repair equipment whatsoever are needed on board the submarine while on a mission. As discussed above, the elimination of these repair-related items reduces servicing costs and frees the limited space on the submarine for other uses.

Also, as discussed above, the servicing strategy 30 may allow a further savings in costs because the periods for maintenance M, refresh R, and technology insertion Tare synchronized. For example, suppose that a part of a system fails at time t4, and is scheduled for refresh at time t5. Because the system is designed to operate during an MFOP without the need for repair, the system continues to operate from time t4 until at least time t5 without repair or replacement of the failed part. At time t5, shore-based personnel can replace the failed part, but because the part is scheduled for refresh anyway, the personnel refresh the part. So instead of replacing/repairing the part at t4 and then refreshing the part shortly thereafter at t5, shore-based personnel “kill two birds with one stone” by refreshing the part at t5, which also effectively repairs the part. Therefore, one saves the costs of a spare part and the testing and other engineering time and effort needed to replace the failed part with the spare part. And if the part is also scheduled for technology insertion at t5, then shore-based personnel “kill three birds with one stone” by performing technology insertion to the part, which also effectively refreshes and repairs the part, and thus saves the cost of a spare part, a refresh part, and the testing and other engineering time and effort needed to replace and then refresh the part.

Furthermore, as discussed above, the servicing strategy 30 may allow even more savings because one or more higher-levels of accessibility, and thus one or more higher levels of maintenance, for the system have been eliminated. Specifically, in the servicing strategy 30, there is only a single accessibility level A, and thus a single maintenance level M. For example, assume that the system is on board a submarine. Referring to FIG. 1, a system compatible with the conventional servicing strategy 10 has a high accessibility level AL3 when the submarine in which the system is installed is in dry dock being overhauled. And the system also has a high level of maintenance ML3 during the period AL3, because this is when the system is most accessible. But the servicing strategy 30 eliminates AL3 and ML3 of FIG. 1 by allowing the system to forego the need for high-level maintenance that can be performed only while the submarine is in dry dock. For example, a conventional system, such as a cooling system, may be maintainable or refreshable only while the submarine is in dry dock. Specifically, parts of the cooling system may be so large that personnel can remove them from the submarine for repair or replacement only by dismantling a portion of the submarine's hull, and the equipment and personnel for dismantling the hull are available only in dry dock. But a cooling system that is compatible with the servicing strategy 30 is modular, i.e., can be broken down into pieces that are small enough to be removed/replaced via the submarine's hatches. Consequently, one saves the costs associated with having to perform certain maintenance on the cooling system or parts thereof only while the submarine is in dry dock. And if all of the systems on board the submarine are designed in this manner, then one can eliminate the need for periodically dry docking the submarine altogether, and can thus reap the associated cost savings. For example, because there are only a handful of submarine dry docks in the world, the fuel and other costs of sailing the submarine to dry dock may be significant. Furthermore, the costs of the submarine being in dry dock, and thus out of commission (e.g., six months or longer), may also be significant.

Still referring to FIG. 3, there are many techniques for developing the servicing strategy 30 or a similar servicing strategy. For example, one may start by choosing the refresh intervals for the system. A technique for choosing the refresh intervals is disclosed in U.S. patent application Ser. Nos. 10/440,438 and 10/440,032, which were previously incorporated by reference. Once one selects the refresh intervals, then he determines the parts-sparing strategy. That is, the parts of a system typically have different anticipated life cycles. So not all parts may be scheduled for refresh during the same refresh period. For those parts that are not scheduled for refresh, they may need replacement because of failure during a previous MFOP. Therefore, spares of these parts are needed, and may be purchased on an ad hoc basis or well in advance, depending on factors, e.g., anticipated price and availability. Techniques for determining a parts-sparing strategy are known, and are thus not discussed in detail. One may then schedule technology insertions well in advance, or on an ad hoc basis (but synchronous with the maintenance and/or refresh periods) depending on the technology advances that occur during the life cycle of the system.

Alternate embodiments of the servicing strategy 30 are contemplated. For example, although the MFOPs are disclosed as each having a constant duration, the MFOPs may be of different durations over the anticipated life cycle of the system. For example, for a system on a submarine, the MFOPs may span four missions when the system is new, and then gradually reduce to two missions as the system ages. Furthermore, although maintenance, refresh, and technology insertion are scheduled at regular intervals, they may be scheduled at different intervals over the anticipated life cycle of the system. For example, for a system on a submarine, the refresh intervals may be after every eighth mission when the system is new, and then gradually reduce to after every fourth mission as the system ages.

Still referring to FIG. 3, as discussed above, one can implement the servicing strategy 30 for a system having accessibility and maintenance levels that are independent of the plant in which the system is installed. Take the example of a computer server in an office building, where the server has the same level of accessibility at all times. Designing the computer server to have MFOPs allows one to schedule maintenance at predetermined times. Consequently, one may be able to eliminate full-time maintenance personnel, and contract out the maintenance to a firm that checks the server only at predetermined intervals. One may also be able to eliminate the need to purchase and retain on-site repair equipment and documentation. Furthermore, as discussed above, one can synchronize the maintenance intervals for the computer server with the server's refresh and technology-insertion intervals to reduce costs even further.

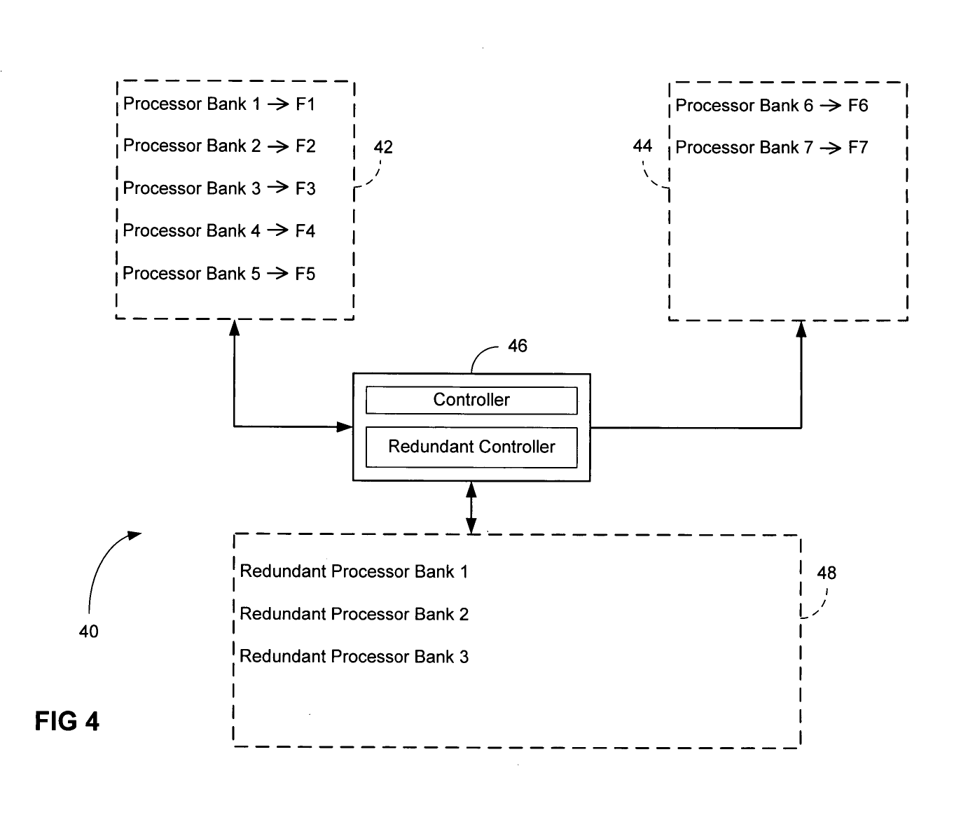

FIG. 4 is a block diagram of a system 40 that is compatible with the servicing strategy 30 of FIG. 3 and with similar servicing strategies according to an embodiment of the invention. The system 40 is operable without repair over a predetermined period of time, i.e., has a non-zero MFOP. That is, the system 40 is designed to be fault-tolerant such that if one portion of the system fails during an MFOP, another portion of the system can “take over” for the failed portion for the remainder of the MFOP, i.e., until the next period during which maintenance M is scheduled. Furthermore, the system requires fewer high levels of accessibility and maintenance. That is, the system 40 is designed so that one can access its parts for maintenance with lower levels of difficulty as compared to prior systems.

The system 40 includes a first portion 42, a second portion 44, a controller portion 46, and a redundant portion 48. The first portion 42 includes five processor banks BANK1-BANK5, which respectively perform functions F1-F5, the second portion 44 includes two processor banks BANK6-BANK7, which respectively perform functions F6-F7, and the redundant portion 48 includes redundant processor banks BANK8-BANK10, which are available to perform functions if one or more of the banks BANK1-BANK7 fails. The controller portion 46 is coupled to and operable to control the operations of the portions 42, 44, and 46. The controller portion 46 also includes a controller 50 and a redundant controller 52, which can take over for the controller 50 if the controller 50 fails.

If for example, the first processor bank BANK1 fails during an MFOP, then the controller 50 maintains the system 40 operational by causing one of the redundant processor banks BANK8-BANK10 to take over the performance of the function F1, which was previously performed by the now-failed BANK1, for at least the remainder of the MFOP. The controller 50 may take this corrective action automatically, or may provide a message to a system operator, who may then enter via, e.g., a keyboard, a command that causes the controller 50 to take the corrective action. Alternatively, the operator may take another action that causes the controller portion 50 to take the corrective action.

Then, service personnel can repair the failed first processor bank BANK1 during the next accessibility period following the MFOP. Or, if BANK1 is scheduled for refresh or technology insertion during the next accessibility period, then service personnel effectively repair the BANK1 when they e.g., replace the processors that compose BANK1 with one or more later-generation processors.

Similarly, if the sixth processor bank BANK6 fails during the MFOP, then the controller 50 maintains the system 40 operational by causing another one of the redundant processor banks BANK8-BANK10 to take over the performance of the function F6 previously performed by the now-failed BANK6 for at least the remainder of the MFOP.

Of course, one of the redundant processor banks BANK8-BANK10 may fail during an MFOP, but the system 40 is designed so that statistically, no more than three of the processor banks BANK1-BANK10 will fail during an MFOP. If, however, more than three of the processor banks fail such that the controller 50 lacks sufficient resources to implement redundancy, personnel often can make an emergency repair to the system 40 during the MFOP. Although such an emergency repair may be relatively expensive and complicated due to the lack of available repair equipment and expertise at the system location—for example, if the system 40 is on board a submarine, then a service team and repair equipment may need to be airlifted to the submarine—such repairs should be infrequent enough that the increased repair cost is offset by the savings realized by designing the system to have MFOPs and synchronizing refresh of and technology insertion to the system with the MFOPs.

Still referring to FIG. 4, by designing the system 40 to be modular, the system may have fewer high levels of accessibility and maintenance. For example, if the system 40 is on board a submarine and can be taken apart in modules that are each small enough to fit through the hatches of the submarine, then one can fully access the system 40 for maintenance while the submarine is in port. Consequently, the system 40 does not require a dry-dock level of accessibility/maintenance. As discussed above, if all of the other systems aboard the submarine also eliminate the dry-dock level of accessibility/maintenance, then the submarine never need be taken to dry dock.

Still referring to FIG. 4, redundancy strategies are contemplated other than those presented in the above example, and one can determine these strategies using known techniques. For example, the controller portion 46 may distribute the function F performed by a failed processor bank to more than one other processor bank. Alternatively, the controller portion 46 may distribute the function F performed by the failed processor bank to other systems (not shown in FIG. 4), or to a combination of other systems and portions of the system 40. Furthermore, if a function F performed by the failed processor bank of the system 40 is not critical, then the controller portion 46 may merely suspend performance of that function for the remainder of the MFOP. In addition, one can formulate a redundancy strategy using conventional statistical techniques that take into account quantities such as the length of the desired MFOP for the system 40, the mean time before failure (MTBF) of the parts that compose the system, and the part space available within the system and the plant in which the system is installed. Because such techniques are known, they are not discussed in detail. Moreover, although not discussed in conjunction with the system 40, one or more parts of the system 40 may be designed to have different MFOPs. For example, one may design the portion 42 to have an MFOP of a first duration, and design the portion 44 to have an MFOP of a second, different duration.

Continuing to refer to FIG. 4, additional features of the system 40 are contemplated. For example, if during an MFOP the system 40 is far from its anticipated location during the next accessibility period when maintenance can be performed (e.g., a submarine on a mission that is serviced in port), the controller 46 may transmit a description of a failure to location-based service personnel, who can then order replacement parts and otherwise prepare for the repair ahead of time. Such preparation may reduce the time needed to make the repair. Furthermore, the ability to order replacement parts may allow one to reduce the number of inventoried parts, or to altogether eliminate a parts' inventory. Moreover, one can design the system 40 or the plant (e.g., submarine) in which the system is installed to accommodate anticipated refreshes and insertion of technology to the parts of the system. For example, the refreshed or inserted parts may consume more power and/or generate more heat than the previous parts. Consequently, one may anticipate the power and cooling capacities that will be needed for these new parts, and design the system and/or plant to have the anticipated power and cooling capacities so that the system/plant can accommodate these anticipated refreshes and insertions of technology.

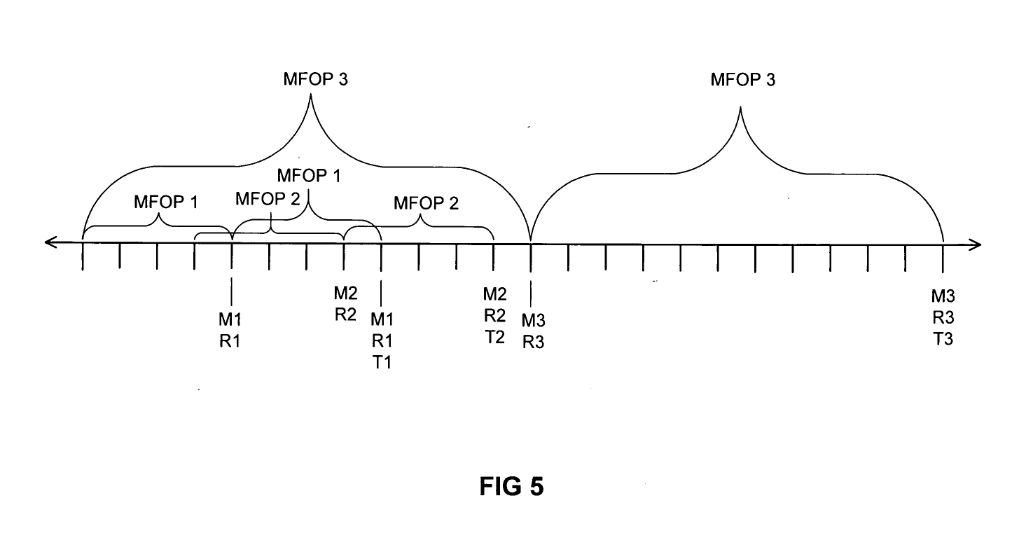

FIG. 5 is a servicing strategy 60 over a portion of three systems' anticipated lifetimes, where the three systems are part of a plant and the maintenance M, the refresh R, and the technology-insertion T for each system are synchronized according to an embodiment of the invention. M1 denotes the periods of maintenance for the first of the three systems, M2 denotes the periods of maintenance for the second of three systems, M3 denotes the periods of maintenance for the third of the three systems, MFOP1 denotes the maintenance-free operating periods for the first of the three systems, etc. Although the strategy 60 is described as covering three systems of the plant, it is contemplated that the strategy can cover fewer or more than two systems of the plant.

MFOP1 and MFOP2 for the first two systems are of the same duration, but are staggered so that maintenance, refresh, and technology insertion for each system are performed at different times. This may be convenient where one desires the first system to be operational while the second system is being maintained, refreshed, or having technology inserted, or vice-versa. For example, suppose that the first system is the HVAC system of a submarine, and the second system is a sonar system. For the comfort of the maintenance personnel, it may be desirable that the HVAC system be operational while the personnel are maintaining the sonar system. Consequently, one schedules maintenance for the HVAC system and maintenance for the sonar system at different times. Furthermore, it may be desirable to stagger the maintenance, refreshes, and technology insertions for the first and second systems to reduce the amount of work simultaneously being performed within the plant at any one time, and to reduce the overall time during any one period that personnel spend performing maintenance, refresh, and technology insertion on the systems within the plant. For example, one may wish that maintenance, refresh, and technology insertions be performed only on weekends, when the plant is not in use. Therefore, he staggers the MFOPs of the systems so that during any one weekend, personnel service only some of the systems.

Furthermore, MFOP3 is longer than MFOP1 and MFOP2. This may be desired where the third system can go longer without repair, refresh, and technology insertion than the first and second systems. For example, one may need to maintain/refresh/insert technology into a nuclear reactor aboard a submarine less frequently than one may need to maintain/refresh/insert technology into a sonar system.

Moreover, although MFOP1 and MFOP2 are staggered and MFOP3 is longer than MFOP1 and MFOP2, where the plant is a submarine, the maintenance, refresh, and technology-insertion for each of the three systems occur while the submarine is in port, and none of these systems requires a dry-dock level of accessibility and maintenance, thus saving costs as discussed above in conjunction with FIGS. 3 and 4.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A system operable for a predetermined period of time without maintenance, the system comprising:
a first portion operable to perform a function;
a second portion; and
a control portion coupled to the first and second portions and operable to cause the second portion to perform the function for a remainder of the predetermined period if the first portion fails during the predetermined period.

2. The system of claim 1 wherein the predetermined period comprises an integer multiple of a mission duration of a vessel on which the system is disposed.

3. The system of claim 1 wherein the control portion is operable to detect a failure that renders the first portion unable to perform the function and to cause the second portion to perform the function in response to detecting the failure.

4. The system of claim 1, further comprising:
a third portion coupled to the control portion; and
wherein the control portion is operable to cause the third portion to perform the function for a remainder of the predetermined period if the first and second portions fail during the predetermined period.

5. A method, comprising:
operating a system for a predetermined period of time without performing maintenance to the system; and
if a first portion of the system performing a function fails during the predetermined period, then causing a second portion of the system to perform the function for a remainder of the predetermined period.

6. The method of claim 5 wherein:
the system is disposed on a vessel; and
the predetermined period comprises an integer multiple of a mission duration of the vessel.

7. The method of claim 5, further comprising:
wherein the system is disposed on a vessel; and
carrying on the vessel no spares for any part of the system.

8. The method of claim 5, further comprising repairing the first portion of the system after the predetermined period ends if the first portion fails during the predetermined period.

9. The method of claim 8 wherein:
the first portion of the system includes a part of a part generation; and
repairing the first portion comprises replacing the part with a part of the same generation.

10. The method of claim 8 wherein:
the first portion of the system includes a part of a part generation; and
repairing the first portion comprises refreshing the first portion by replacing the part with a part of a later part generation.

11. The method of claim 8 wherein:
the first portion of the system includes a number of parts of respective part generations and has a capacity for performing the function; and
repairing the first portion of the system comprises refreshing the first portion of the system by replacing the parts with fewer later-generation parts such that after the repairing, the first portion of the system has substantially the same capacity for performing the function as before the repairing.

12. The method of claim 8 wherein:
the first portion of the system includes a first number of parts of respective part generations and has a capacity for performing the function; and
repairing the first portion of the system comprises inserting new technology into the first portion of the system by replacing the parts with a second number of later-generation parts such that after the repairing, the first portion of the system has a greater capacity for performing the function than before the repairing.

13. The method of claim 12 wherein the second number is less than or equal to the first number.

14. The method of claim 5, further comprising causing a third portion of the system to perform the function for the remainder of the predetermined period if the first and second portions of the system fail during the predetermined period.

15. The method of claim 5, further comprising refreshing the system at an interval that is an integer multiple of the predetermined period.

16. The method of claim 5, further comprising inserting technology into the system at an interval that is an integer multiple of the predetermined period.

17. An apparatus, comprising:
a first system that is operable to perform a first function and that is repairable only during predetermined maintenance periods;
a second system; and
a control system coupled to the first and second systems and operable to cause the second system to perform the first function until the next predetermined maintenance period if the first system fails between maintenance periods.

18. The apparatus of claim 17 wherein:
the second system is operable to perform a second function; and
the control-system is operable to cause the second system to perform the first and second functions until the next predetermined maintenance period if the first system fails between maintenance periods.

19. The apparatus of claim 17 wherein a duration between consecutive maintenance periods comprises an integer multiple of a mission duration of the apparatus.

20. The apparatus of claim 17 wherein the first system comprises an electronic part.

21. The apparatus of claim 17 wherein the first system, the second system, and the control system are parts of a same system.

22. A method, comprising:
detecting a failure of a system between predetermined maintenance periods;
if the system was performing a task before the failure, then performing the task without the system until a next predetermined maintenance period; and
repairing the system during the next predetermined maintenance period.

23. The method of claim 22 wherein the failure comprises a failure of a part of the system.

24. The method of claim 22 wherein:
the system is disposed on a vessel; and
the predetermined maintenance periods coincide with times during which the vessel is in respective predetermined locations.

25. The method of claim 22 wherein:
the system includes a part of a part generation; and
repairing the system comprises replacing the part with a part of the same generation.

26. The method of claim 22 wherein:
the system includes a part of a part generation; and
repairing the system comprises replacing the part with a part of a later generation.

27. The method of claim 22 wherein:
the system includes a number of parts of respective part generations and has a functional capacity; and
repairing the system comprises replacing the parts with fewer subsequent-generation parts such that after the repairing, the system has substantially the same functional capacity.

28. The method of claim 22 wherein:
the system includes a first number of parts of respective part generations and has a functional capacity; and
repairing the system comprises replacing the parts with a second number of subsequent-generation parts such that after the repairing, the system has an increased functional capacity.

29. The method of claim 22 wherein the second number is less than or equal to the first number.

30. A method, comprising:
operating a system for a predetermined period of time without performing maintenance to the system;
if a first portion of the system performing a function fails during the predetermined period, then causing a second portion of the system to perform the function for a remainder of the predetermined period; and
refreshing the first portion of the system after the predetermined period of time, the refreshing causing the first portion to be repaired if the first portion failed during the predetermined period of time.

31. A method, comprising:
designing a system to have predetermined maintenance-free operability periods; and
scheduling technology refreshes of the system at intervals that are no longer than the respective maintenance-free operability periods.

32. The method of claim 31, further comprising scheduling technology insertions to the system to occur simultaneously with at least some of the technology refreshes.

33. The method of claim 31 wherein scheduling the technology refreshes further comprises synchronizing the technology refreshes with the maintenance-free operating periods.

34. A method, comprising:
designing a system to have predetermined maintenance-free operability periods; and
scheduling technology insertions to the system at intervals that are no longer than the respective maintenance-free operability periods.

35. The method of claim 34 wherein scheduling the technology insertions further comprises synchronizing the technology insertions with the maintenance-free operating periods.
